(19) United States
(12) Patent Application Publication
(10) Pub. No.: US 2026/0120002 A1
(43) Pub. Date: Apr. 30, 2026

(54) AUTOMATED MULTI-MODAL REGISTRATION OF ARTIFICIAL INTELLIGENCE AGENTS

(71) Applicant: BOOMI, LP, Conshohocken, PA (US)

(72) Inventors: Ayush PARASHAR, Foster City, CA (US); Swagata ASHWANI, San Francisco, CA (US); Abhay SASWADE, Sunnyvale, CA (US); Sandeep SINGH, Cumming, GA (US)

(73) Assignee: BOOMI, LP, Conshohocken, PA (US)

(21) Appl. No.: 19/341,969

(22) Filed: Sep. 26, 2025

(30) Foreign Application Priority Data
Oct. 25, 2024 (IN) 202411081537
Oct. 25, 2024 (IN) 202411081538

(51) Int. Cl. G06N 20/20

(52) U.S. Cl. CPC G06N 20/20

(57) ABSTRACT

Conventionally, artificial intelligence (AI) agents must be manually registered with platforms, which results in a lack of scalability, as the number of AI agents continues to surge into the millions and hundreds of millions, a lack of compatibility and standardization between agent specifications, and siloes of AI agents that cannot be combined into a unified registry. Accordingly, disclosed embodiments provide a AI-powered registration service that is capable of automatically registering AI agents, regardless of input format and regardless of the framework in which those AI agents are defined, using a standard agent schema, into a unified and centralized registry. In turn, this unified registry improves searching and discovery of AI agents.

### CROSS-REFERENCE TO RELATED APPLICATIONS

The present application claims priority to Indian Patent Application No. 202411081537, filed on Oct. 25, 2024, and Indian Patent Application No. 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to automated multi-modal registration of AI agents.

### Description of the Related Art

Numerous platforms exist that enable users to construct and/or utilize artificial intelligence (AI) agents. An AI agent is a software entity that utilizes artificial intelligence to autonomously perform one or more tasks, in order to achieve an objective set by a human, other software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective.

Conventionally, AI agents are manually registered with a platform. This requires a technical expert to expend significant effort to manually generate an agent specification for each AI agent to be registered. In particular, the technical expert must manually analyze the code of the AI agent, documentation for the AI agent, and/or configuration files for the AI agent, to identify and extract the key attributes of the AI agent into an agent specification.

Exacerbating this effort, there is no standard framework for the definitions of AI agents. Rather, AI agents may be defined within numerous and diverse frameworks. Thus, a technical expert must have significant expertise to be able to analyze and extract the appropriate data from all of these diverse frameworks. This represents a substantial bottleneck that prevents the scalable registration of new agentic deployments, which may number in the millions. As a result, there is a substantial time lag between when a new AI agent is available, and when it can be searched and discovered within a registry of AI agents.

Furthermore, manual registration of AI agents, defined in diverse frameworks, by different technical experts, has resulted in fragmented documentation approaches. These approaches lack standardization across frameworks and platforms. This makes it difficult to search and discover AI agents, not only across different frameworks, but also across teams, departments, and other organizational units. Consequently, agent registries become siloed, unable to be integrated together, resulting in a lack of unified visibility of AI agents across organizational units and platforms.

### SUMMARY

Accordingly, systems, methods, and non-transitory computer-readable media are disclosed for automated multi-modal registration of artificial intelligence (AI) agents, to provide a unified registry of AI agents.

In an embodiment, a method comprises using at least one hardware processor to, by a registration service: receive an input file defining an artificial intelligence (AI) agent; classify the input file into one of a plurality of frameworks, wherein each of the plurality of frameworks is a framework by which the AI agent may be defined; retrieve one or more patterns for the one framework; extract data from the input file based on the one or more patterns; apply an AI model to the extracted data to generate an agent specification for the AI agent according to a standard agent schema; and add the agent specification to a registry of AI agents.

The method may further comprise using the at least one hardware processor to, by the registration service, before adding the agent specification to the registry of AI agents, validate the agent specification.

The method may further comprise using the at least one hardware processor to, before classifying the input file: detect a format of the input file; and extract characteristic data from the input file, based on the detected format. Classifying the input file into the one framework may comprise: deriving a plurality of features from the characteristic data; and applying a classification model to the plurality of features to classify the input file into the one framework. The plurality of frameworks may comprise two or more versions of a same framework. The classification model may be an ensemble model that comprises at least one rule-based model and at least one machine-learning model.

Classifying the input file into one of the plurality of frameworks may comprise: extracting one or more input schema patterns from the input file; for each of the one or more input schema patterns, converting the input schema pattern into an input embedding vector, searching a vector database for any reference embedding vectors that are similar to the input embedding vector according to a similarity metric, wherein each of the reference embedding vectors is associated with one of the plurality of frameworks; and determining the one framework based on the frameworks that are associated with the reference embedding vectors that are found in the search.

Extracting data from the input file based on the one or more patterns may comprise extracting data from each portion of the input file that matches one of the one or more patterns.

The AI model may be a generative language model, wherein applying the AI model to the extracted data comprises: generating a prompt that comprises at least a portion of the extracted data; and inputting the prompt to the generative language model to produce the agent specification. The prompt may further comprise the standard agent schema.

The AI model may generate both the agent specification and a confidence score for the agent specification, wherein the confidence score represents how confident the AI model is about the correctness of the agent specification. The method may further comprise using the at least one hardware processor to, by the registration service, determine whether or not to automatically validate the agent specification based on the confidence score. Determining whether or not to automatically validate the agent specification may comprise: determining to automatically validate the agent specification when the confidence score satisfies a threshold; and determining not to automatically validate the agent specification when the confidence score does not satisfy the threshold. The method may further comprise using the at least one hardware processor to, by the registration service, when determining to automatically validate the agent specification, automatically add the agent specification to the registry without user involvement. The method may further comprise using the at least one hardware processor to, by the registration service, when determining not to automatically validate the agent specification, block the addition of the agent specification to the registry until an approval of the agent specification is received.

Adding the agent specification to the registry may comprise performing a remote procedure call to an endpoint within an application programming interface of the registry.

The registration service may be hosted on an integration platform as a service (iPaaS) platform.

The plurality of frameworks may comprise two or more different frameworks and two or more versions of a same framework.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for automated multi-modal registration of artificial intelligence (AI) agents, according to an embodiment; and

FIG. 4 illustrates an example process for automated multi-modal registration of AI agents, according to an embodiment.

### DETAILED DESCRIPTION

In an embodiment, systems, methods, and non-transitory computer-readable media are disclosed for automated multi-modal registration of artificial intelligence (AI) agents. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

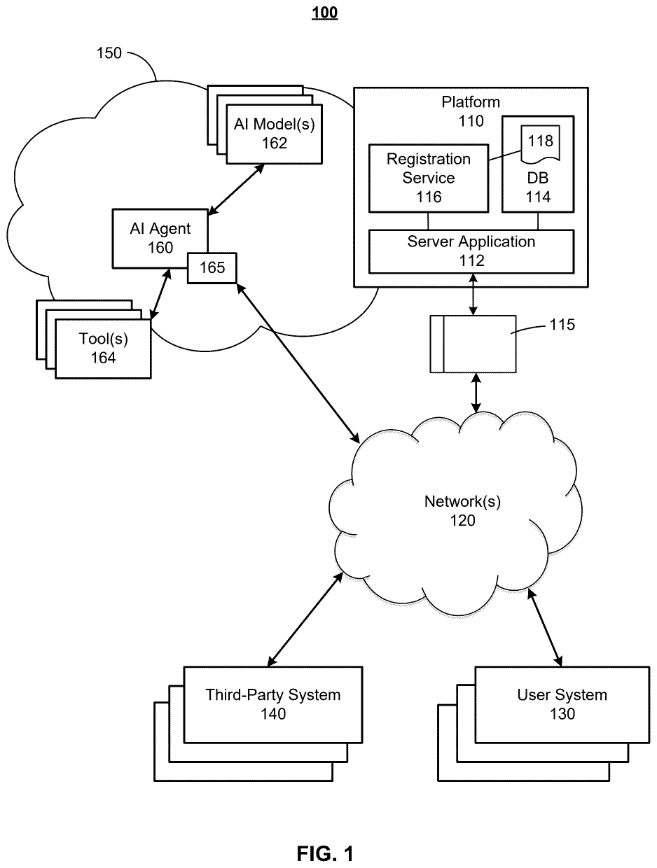

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or host a database 114 that may store data used by server application 112. Platform 110 may also execute a registration service 116 (e.g., as part of or in collaboration with server application 112), which automatically adds AI agents 160 to a catalog or registry 118 (e.g., stored in database 114), as described in greater detail elsewhere herein. Registration service 116 may itself be an AI agent 160, although this is not a requirement. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a developer or other stakeholder in AI agents 160, who has a user account for accessing server application 112 on platform 110. It should be understood that the user may be anywhere from an expert software engineer, with extensive knowledge of how to construct an AI agent 160, to a business decision-maker, lay person, or other non-technical person, with little to no knowledge of how to construct an AI agent 160. Each user account may be associated with an overarching organizational account for managing software entities, including AI agents 160, being developed by an organization using platform 110.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes. While only a single AI agent 160 is illustrated, it should be understood that computing environment 150 may comprise or be communicatively coupled to a plurality of AI agents 160, including potentially hundreds, thousands, millions, tens of millions, hundreds of millions, billions, tens of billions, hundreds of billions, or more AI agents 160.

The user of a user system 130 may authenticate with platform 110 using standard authentication means, to access server application 112 in accordance with permissions or roles of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface (API) of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support one or more AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through application programming interface.

Similarly, each AI agent 160, when deployed, may be communicatively coupled to network(s) 120. In particular, each AI agent 160 may comprise an agentic interface 165, which may comprise a user interface, including potentially a graphical user interface, and/or an application programming interface. A client may interact with AI agent 160, via agentic interface 165, to submit inputs and receive responses from AI agent 160, push data to AI agent 160, pull or otherwise receive data from AI agent 160, and/or the like. In the event that agentic interface 165 comprises a user interface, AI agent 160 may be a conversational agent that receives natural-language inputs from a user and outputs natural-language responses to the user.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 and/or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

In an embodiment, the software entities(s) being developed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude 3 Opus, Claude 3.7 Sonnet) developed by Anthropic PBC of San Francisco, California, the Falcon large language model (e.g., Falcon 160B) released by the United Arab Emirates'Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like.

Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be a conversational or chat AI agent. In this case, agentic interface 165 may implement a chat interface. The chat interface may be comprised or embedded (e.g., as an overlaid chat frame) within a user interface of agentic interface 165, which may itself be comprised or embedded within user interface 115 of server application 112. The chat interface may be a graphical user interface, an audio interface, or a combination of graphical and audio user interface (i.e., an audiovisual interface).

### 2. Example Processing System

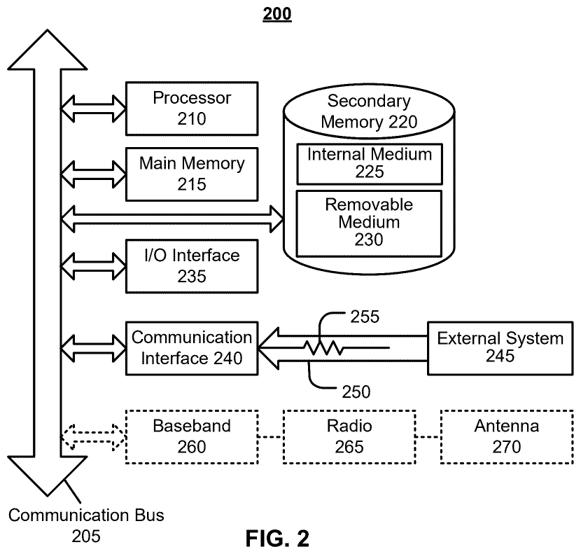

FIG. 2 illustrates an example processing system 200, by which one or more of the processes described herein may be executed, according to an embodiment. For example, system 200 may be used to store and/or execute server application 112, registration service 116, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Data Flow

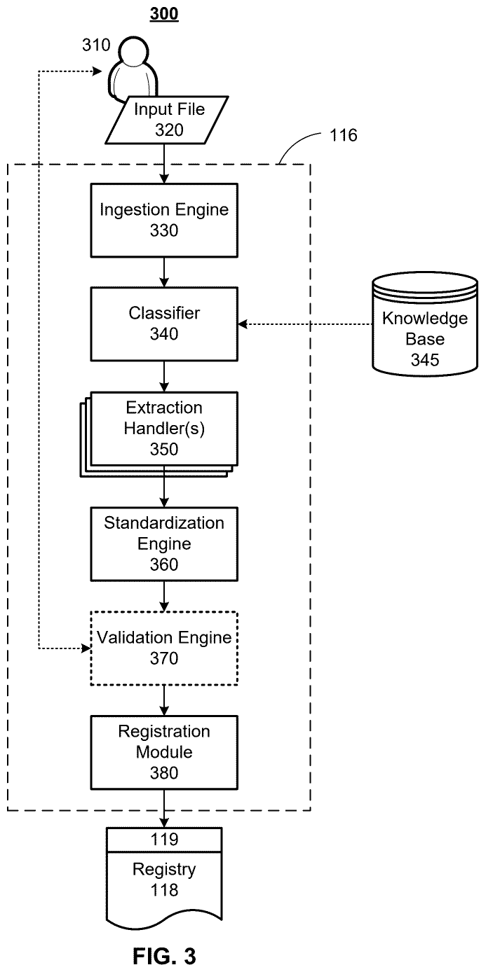

FIG. 3 illustrates an example data flow 300 for automated multi-modal registration of artificial intelligence (AI) agents, according to an embodiment. It should be understood that data flow 300 is shown by way of example, rather than limitation, and that a myriad other arrangements of the data flow are possible. In the illustrated embodiment, registration service 116 comprises an ingestion engine 330, classifier 340, one or more extraction handlers 350, a standardization engine 360, an optional validation engine 370, and a registration module 380. These components collaborate to provide frictionless registration of AI agents 160.

Registration service 116 may be triggered by an end client 310 submitting an input file 320. End client 310 may be a user (e.g., via user system 130) or a software entity. When end client 310 is a user, end client 310 may submit or otherwise specify input file 320 via a user interface, such as a graphical user interface, of registration service 116. When end client 310 is a software entity, end client 310 may submit or otherwise specify input file 320 via an application programming interface of registration service 116. In an embodiment in which registration service 116 is an AI agent 160, registration service 116 may receive input file 320 via agentic interface 165, which may comprise the user interface and/or application programming interface. Alternatively, in an embodiment in which registration service 116 is a module of server application 112, registration service 116 may receive input file 320 via an interface of server application 112 (e.g., user interface 115 and/or an application programming interface (not shown) of server application 112).

Ingestion engine 330, which may be implemented within registration service 116, may receive input file 320, representing an AI agent 160. In an embodiment, ingestion engine 330 is configured to ingest input files 330 in a plurality of different formats in which AI agents 160 may be defined. Examples of formats, in which AI agents 160 may be defined, include, without limitation, a code repository (e.g., GitHub by Microsoft Corporation of Redmond, Washington, Bitbucket of Atlassian Corporation of Sydney, Australia, etc.), a code file (e.g., one or more computer files representing source code for AI agent 160), one or more image files (e.g., representing screenshots representing a configuration of AI agent 160), a Portable Document Format (PDF) file, a configuration file (e.g., expressed in eXtensible Markup Language (XML) or other markup language), a plain text file, and/or the like. While input file 320 is expressed in the singular, it should be understood that input file 320 could, in practice, comprise a plurality of separate computer files, potentially including separate computer files in two or more different formats. In this case, it should be understood that ingestion service 330 may process each computer file separately.

Ingestion engine 330 may perform any necessary preprocessing for input file 320. This preprocessing may comprise, when input file 320 is a container (e.g., Zip archive file, multi-file code repository, etc.), extracting embedded content from the container. In addition, ingestion engine 330 may handle any authentication necessary to access private code repositories, using the applicable authentication protocol (e.g., Open Authorization (OAuth), token-based authentication, Secure Shell (SSH) keys, etc.). Ingestion engine 330 may also implement rate limiting and/or throttling for external API calls.

Ingestion engine 330 may automatically detect the format of input file 320. For example, ingestion engine 330 may analyze the file extension of input file 320, content headers in or encapsulating input file 320, data patterns within input file 320, and/or the like to detect the format of input file 320. For ambiguous formats, which cannot be easily detected based on the file extension and/or content header(s), ingestion engine 330 may utilize a content-type “sniffing” algorithm to detect the format. Once the format has been detected, ingestion engine 330 may employ format-detection heuristics to validate the detected format of input file 320.

A code repository is an online data store of source code, representing a software implementation of AI agent 160, that enables developers to track changes to the source code, collaborate with other developers on the source code, share the source code with other developers, and/or the like. In the event that input file 320 is a code repository, end client 310 may submit a uniform resource locator (URL) of the code repository, instead of input file 320 itself. Ingestion engine 330 may automatically clone the resource (e.g., webpage) at the URL and/or utilize an application programming interface of the code repository to retrieve the source code, potentially including configuration files, of the AI agent 160 represented by the URL. A configuration file of an AI agent 160 may define the behavior of AI agent 160.

A code file comprises one or more computer files that comprise the source code for AI agent 160. Ingestion engine 330 may be configured to handle code files, expressed in any programming language. Typically, the source code for an AI agent 160 will be expressed in Python, JavaScript, or JavaScript Object Notation (JSON). However, the particular programming language is not a limitation on ingestion engine 330.

An image file may comprise a screenshot of a representation of AI agent 160. For example, a screenshot may be of a graphical user interface in which one or more configurable parameters of AI agent 160 are displayed. A user may utilize the graphical user interface to specify values for the configurable parameter(s), and then perform a screen capture to generate the screenshot of the configuration of AI agent 160. Ingestion engine 330 may execute a suitable optical character recognition (OCR) algorithm on each image file to convert any text in the image file into plain text format. Additionally or alternatively, AI agent 160 may utilize one or more other image analyses to extract structured data from each image file. The text and/or other data may represent a configuration (e.g., the value of each of one or more configurable parameters) of AI agent 160. It should be understood that the extracted data are capable of being read by a machine.

A PDF file may comprise a documentation of AI agent 160 that includes textual and/or graphical elements. Ingestion engine 330 may extract data from the PDF file. The data may comprise text, tables, and/or the like, representing the configuration of AI agent 160.

Ingestion engine 330 may extract data from other formats, such as XML or other markup language, plain text, and/or the like, in a similar manner. In general, ingestion engine 330 may detect the format of input file 320, and extract characteristic data from input file 320 based on the detected format.

Ingestion engine 330 may preprocess the characteristic data that are extracted from input file 320. This preprocessing may comprise normalizing the characteristic data, for example, by converting text into a common or standardized text encoding, standardizing line endings across the different formats, and/or the like.

Classifier 340, which may be implemented within registration service 116, may classify input file 320, received by ingestion engine 330, into one of a plurality of frameworks. More particularly, classifier 340 classifies the definition of AI agent 160 within input file 320 into one of the plurality of frameworks in which AI agents 160 may be defined. The plurality of frameworks may comprise any framework that can be used to define an AI agent 160. Examples of frameworks, which may be included in the plurality of frameworks, include, without limitation, CrewAI, LangChain from LangChain Inc. of San Francisco, California, LlamaIndex from LlamaIndex Incorporated of San Francisco, California, Salesforce Einstein from Salesforce, Incorporated of San Francisco, California, Workday Adaptive Planning from Workday, Incorporated of Pleasanton, California, Microsoft AutoGen from Microsoft Corporation of Redmond, Washington, Auto-GPT, MetaGPT from Meta Platforms, Inc. of Menlo Park, California, ServiceNow AI Agents from ServiceNow, Incorporated of Santa Clara, California, Adobe Experience Platform Agent Orchestrator from Adobe Incorporated of San Jose, California, and/or the like. Different frameworks may have differing levels of abstraction. For instance, some frameworks may include source code for AI agents 160, whereas other frameworks may include no source code for AI agents 160 and/or consist only of high level definitions of AI agents 160.

Classifier 340 may analyze the characteristic data, output by ingestion engine 330, to extract features to be input to a machine-learning classification model (e.g., AI model 162 in the event that registration service 116 or classifier 340 is itself an AI agent 160). When the characteristic data comprise source code, this analysis may comprise identifying import statements, package dependencies, class structures, and/or the like, which are indicative of specific frameworks. The analysis may use an abstract syntax tree (AST) to parse the source code to identify patterns in the source code. These identified patterns may be compared to framework-specific reference patterns, in a signature library, to identify the presence or absence of framework-specific patterns in the source code, such as a framework-specific initialization pattern. N-gram analysis may be used to identify framework-specific coding conventions.

It should be understood that different frameworks may comprise different structures and/or patterns that can be detected by classifier 340 and used as differentiators for the frameworks in the classification model. Indications of these differentiators (e.g., a value of a differentiator, a binary indication of the presence or absence of a differentiator, etc.) can be used as features to the classification model of classifier 340. For example, CrewAI may comprise and be differentiated by role-based agent definitions and task delegation patterns, LangChain may comprise and be differentiated by chains, tools, and agent definition constructs, LLamaIndex may comprise and be differentiated by index structures, query engines, and retrieval patterns, Salesforce Einstein may comprise and be differentiated by API usage and custom model definitions, Workday Adaptive Planning may comprise and be differentiated by planning agents and workflow automation, Microsoft AutoGen may comprise and be differentiated by multi-agent conversation constructs and group chats, Auto-GPT may comprise and be differentiated by autonomous goal-driven agent patterns, MetaGPT may comprise and be differentiated by role-based software development agent structures, ServiceNow AI Agents may comprise and be differentiated by workflow automation and service delivery agents, Adobe Experience Platform Agent Orchestrator may comprise and be differentiated by customer journey orchestration patterns, and/or the like.

In an embodiment, classifier 340 supports version detection, to handle the evolution of frameworks and backwards compatibility. In particular, analysis may extract differentiators, not only between different frameworks, but also between different versions of the same framework. In this case, the plurality of frameworks, into which an input file 320 may be classified, will include not only different frameworks, but different versions of the same framework.

A classification model may be applied to the set of features (e.g., represented as a feature vector), extracted by the analysis, to generate a classification of the framework, from among the plurality of frameworks. The classification model may utilize an ensemble approach that combines rule-based detection with machine-learning classification. For example, a rule-based model may be applied to the features or a subset of features, and a machine-learning model may be applied to the feature or another subset of features, to produce two predictions of the framework, which may be aggregated in any suitable manner (e.g., if the two predictions differ, selecting the prediction associated with the higher confidence, ranking the frameworks based on likelihood and selecting the predicted framework with the higher likelihood, etc.).

In an embodiment, classifier 340 may utilize a knowledge base 345. Knowledge base 345 may comprise a knowledge representation of agent schemas, including the patterns utilized within the agent schema for each of the plurality of frameworks. In addition, knowledge base 345 may comprise a hierarchical taxonomy of agentic capabilities across all of the different frameworks, such that each capability of AI agent 160 can be standardized to a taxonomic capability. Similarly, knowledge base 345 may comprise mapping tables that map framework-specific terms to standardized terms. Knowledge base 345 may also comprise ontological relationships between equivalent concepts across frameworks, so that the same concept in two different frameworks can be mapped to each other.

In an embodiment, the knowledge representation of agent schemas, in knowledge base 345, comprises a vector database, which enables semantic similarity matching. In this case, reference schema patterns, within the agent schemas for the supported frameworks, may be stored in a vector database, within knowledge base 345. One or a plurality of reference schema patterns may be extracted from the agent schema for each framework. Each reference schema pattern may be converted to an embedding vector. Each embedding vector comprises a vector of real numbers, with each real number representing a position of the schema pattern within a different dimension of the plurality of dimensions of the vector space. Each embedding vector will have a length equal to the number of dimensions within the vector space. In practice, the vector space may comprise a hundred or more dimensions, and preferably hundreds of dimensions (e.g., seven-hundred-sixty-eight dimensions). The embedding vectors for the reference schema patterns may be stored in the vector database of knowledge base 345. The vector database represents the entire universe of semantic meaning, and the position, defined by each embedding vector, represents a semantic meaning of the associated reference schema pattern within that universe. To search the vector database, a query schema pattern may be converted into an embedding vector, in the same manner as the reference schema patterns were converted into embedding vectors. This embedding vector, representing the query schema pattern, may then be compared to embedding vectors in the vector database, according to a similarity metric. The similarity metric may be based on a distance (e.g., Euclidean distance, Manhattan distance, Cosine distance, Hamming distance, Minkowski distance, Chebyshev distance, Jaccard distance, Haversine distance, Sorensen-Dice distance, etc.) between embedding vectors, with smaller distances representing more similarity and larger distances representing less similarity. The search of the vector database may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search, Approximate Nearest Neighbors Oh Yeah (ANNOY), scalable nearest neighbors (ScaNN), etc.), Hierarchical Navigable Small World (HNSW) graphs, Voronoi diagrams, vector quantization, product quantization (PQ), random projection trees, lattice-based methods (e.g., cover tree, vantage point tree, etc.), and/or the like. In a preferred embodiment, a nearest neighbor algorithm is used. It should be understood that the search of the vector database of knowledge base 345 will return representations of reference schema patterns that are semantically similar to the query schema pattern (e.g., for which the similarity metric satisfies a threshold representing sufficient similarity).

Each of the vector embeddings, in the vector database of knowledge base 345, may be tagged with an identifier of the framework from which the reference schema pattern was derived. Classifier 340 may extract one or more schema patterns from input file 320, convert each schema pattern into an input embedding vector, and query the vector database using the input embedding vector(s) to retrieve reference embedding vectors that are similar to each input embedding vector. Each of the retrieved reference embedding vectors will be tagged with a framework identifier, such that the framework for each reference embedding vector can be easily identified. The framework for input file 320 may then be determined based on the framework identifier(s) returned by the query (e.g., by selecting the framework with the higher occurrence in the search results, the framework associated with reference embedding vectors having the highest overall similarity to the input embedding vector(s), etc.). It should be understood that the vector database, with similarity search capabilities, may represent the machine-learning model of an ensemble approach to the classification model of classifier 340 (e.g., to be aggregated with the determination made by a rule-based model).

As discussed above, knowledge base 345 may have searching and matching capabilities. For example, knowledge base 345 may have a semantic search function that utilizes the vector database to identify similar schema patterns, as described above. In addition, knowledge base 345 may provide fuzzy matching algorithms for handling variations in terminology between different frameworks. Knowledge base 345 may also have context-aware similarity functions that consider the domain and purpose of each AI agent 160, when performing a search.

In an embodiment, knowledge base 345 implements one or more integration technologies that enable knowledge base 345 to be integrated with external systems. For example, knowledge base 345 may implement Amazon OpenSearch for efficient similarity matching and scalability. Knowledge base 345 may also comprise a versioned schema repository, in which a representation of each version of each agent schema for each framework is stored, to enable the evolution of each agent framework to be tracked and analyzed. Knowledge base 345 may implement real-time update mechanisms, so that new schema patterns can be incorporated into knowledge base 345 (e.g., added as a vector embedding to the vector database) in real time. In addition, a feedback loop may be implemented for knowledge base 345 to refine matching based on successful extractions (e.g., by extraction handler(s) 350).

In an embodiment, the classification model produces a confidence score for the determined framework, which represents the confidence of the classification. In particular, the classification model may output a confidence score for each of the plurality of frameworks, and the final classification (i.e., the determined framework) may be selected by classifier 340 based on the confidence scores for the plurality of frameworks. In a simple embodiment, the framework with the highest confidence score may be output as the final classification. Alternatively, the framework with the highest confidence score may be output as the final classification, only if that highest confidence score satisfies (e.g., is greater than or equal to) a threshold representing sufficient confidence. Otherwise, classifier 340 may output the framework as undeterminable. As another alternative, the framework with the highest confidence score may be output as the final classification, only if that highest confidence score exceeds the next highest confidence score by a threshold amount. Otherwise, classifier 340 may output the framework as undeterminable. As alternatives, classifier 340 could output the final classification as a hybrid of the framework with the highest confidence score and the framework with the next highest confidence score, output the final classification as a hybrid of the framework with the highest confidence score and the framework with the next highest confidence score only if both confidence scores satisfy (e.g., are greater than or equal to) a threshold, or the like. In any case, the output by classifier 340 may comprise the framework identifier for the framework into which AI agent 160 has been classified (e.g., or the framework identifiers for all frameworks in a hybrid classification), and the corresponding confidence score (e.g., or confidence scores for all frameworks in a hybrid classification). The confidence score(s) may be utilized by one or more downstream functions, such as validation engine 370.

One or more extraction handlers 350, which may be implemented within registration service 116, may extract data from input file 320 based on one or more patterns, which may be retrieved for the framework into which input file 320 was classified by classifier 340. In particular, each framework may be associated with one or more patterns (e.g., in knowledge base 345), and the pattern(s) may be retrieved (e.g., from knowledge base 345) using the framework identifier(s) output by classifier 340. Extraction handler(s) 350 may utilize context-aware extraction strategies that consider relationships between components of input file 320. Extraction handler(s) 350 may also implement fallback mechanisms for handling non-standard or custom input files 320.

In an embodiment, a single extraction handler 350 may be instantiated for all pattern(s) retrieved for the framework. In this case, each of the plurality of frameworks may be associated with a specialized extraction handler 350. The specialized extraction handler 350 may be tailored to extract data from input file 320 based on the unique structure of the framework. In other words, the specialized extraction handler 350 may have specialized knowledge of the configuration formats and conventions of the respective framework. Different versions of the same framework may be associated with different extraction handlers 350 for version-aware data extraction that is capable of adapting to evolving patterns within the same framework.

In an alternative embodiment, a specialized extraction handler 350 may be instantiated for each pattern that is associated with the determined framework. In this case, each specialized extraction handler 350 is configured to extract data for a respective pattern that is associated with the determined framework. Thus, if the determined framework is associated with a plurality of patterns, a plurality of specialized extraction handler 350 are instantiated. In this case, the specialized extraction handlers 350 may execute in parallel.

Extraction handler 350 may utilize template-based extraction. In other words, a pattern may be represented by a template that is matched to input file 350. When a template matches a portion of input file 350, data may be extracted from that portion of input file 350, according to the template. The templates may be optimized for each format and/or framework. Extraction handler 350 may extract pattern-matched data from input file 350 into structured data that can be used by one or more downstream functions (e.g., standardization engine 360).

Extraction handler 350 may perform role and purpose detection, instruction and guardrail identification, model detection, tool integration analysis, task capability extraction, and/or the detection of other key components of AI agent 160. The role and purpose detection may extract a description of AI agent 160, intended use cases for AI agent 160, and/or capabilities of AI agent 160, from input file 320. The instruction and guardrail identification may identify system prompts for AI agent 160, constraints on AI agent 160, and/or safety measures for AI agent 160, from input file 320. The model detection may identify the AI models 162 that AI agent 160 is designed to utilize. The tool integration analysis may map connections between AI agent 160 and external services, application programming interfaces, data sources, and/or the like. The task capability extraction may identify the specific functions that can be performed by AI agent 160 (e.g., utilizing one or more AI models 162 and/or tools 164).

Extraction handler 350 is capable of multi-modal processing. In other words, extraction handler 350 may be configured to extract data from input files 320 in different formats. For example, extraction handler 350 may utilize optical character recognition, with layout understanding, to convert image files (e.g., screenshots) into text. As another example, extraction handler 350 may utilize document structure analysis, with table extraction, to convert PDF files into structured data. As yet another example, extraction handler 350 may utilize code structure analysis to convert code repositories and/or code files into structured data. Thus, extraction handler 350 is capable of extracting data regardless of the particular format of input file 320.

Standardization engine 360, which may be implemented within registration service 116, may apply an AI model (e.g., AI model 162 in an embodiment in which registration service 116 or standardization engine 360 is an AI agent 160) to the data, extracted by extraction handler(s) 350, to generate an agent specification for AI agent 160, according to a standard agent schema. In an embodiment, the AI model is a generative language model, such as a large language model. In a particular implementation, the AI model was from the Claude Sonnet family of large language models (e.g., deployed on Amazon Bedrock), which provides a good compromise between fast responses and thoughtful, detailed responses. However, it should be understood that any other large language model may be used and/or other types of machine-learning models may be used.

The output of standardization engine 360 may comprise the agent specification for AI agent 160 in a standard agent schema. The agent specification may be output in JSON format or any other suitable format. In an embodiment that comprises validation engine 370, the output of standardization engine 360 may also comprise a confidence score for each field in the agent specification and/or a confidence score for the entire agent specification (e.g., based on an aggregation of the confidence scores for the fields in the agent specification), to guide validation engine 370. In addition, the output of standardization engine 360 may comprise an explanation for any ambiguous fields and/or an incomplete agent specification.

In an embodiment in which standardization engine 360 applies a generative language model to the extracted data to generate the agent specification, standardization engine 360 may generate a prompt. In particular, standardization engine 360 may incorporate the structured data, extracted by extraction handler(s) 350, into a predefined template to generate the prompt, which may comprise or consist of a natural-language expression. The predefined template may comprise a pre-conversation and/or post-conversation, which provide context and/or instructions for the generative language model, and one or more placeholders into which the extracted data are inserted. The pre-conversation and/or post-conversation may define the role of the generative language model (e.g., to generate an agent specification from the extracted data, etc.), define an output format (e.g., the standard agent schema, etc.), and/or the like. The prompt is input to the generative language model to produce a response from the generative language model (e.g., according to the standard agent schema defined by the prompt). This response is the agent specification, and optionally one or more confidence scores for the agent specification (e.g., an overall confidence score, a confidence score for each field, and/or the like), which may then be formatted by standardization engine 360 into a standard output format (e.g., JSON).

Standardization engine 360 may have transformation capabilities. For example, standardization engine 360 may map agent schemas from framework-specific formats to a unified representation (i.e., standard agent schema). In addition, standardization engine 360 may normalize the descriptions of the capabilities of each AI agent 160 for consistent terminology. Standardization engine 360 may also standardize version information and dependencies between components, and resolve conflicting or redundant information from multiple sources.

Standardization engine 360 may enforce consistency across all agent specifications for all frameworks. For example, standardization engine 360 may standardize the terminology across different framework nomenclatures, normalize the format for structured fields (e.g., API endpoints), use canonical representations of common patterns (e.g., authentication methods), normalize version numbers to handle different versioning schemes, and/or the like.

Validation engine 370, which may be implemented within registration service 116, may validate the agent specification that was generated by standardization engine 360. Validation engine 370 may validate the agent specification, output by standardization engine 360, to ensure that the agent specification contains all required fields. Validation engine 370 may also perform a semantic validation to ensure that the agent specification is internally logically consistent. In addition, validation engine 370 may perform cross-referencing validation between interdependent components of the agent specification. In addition, validation engine 370 or other software entity could analyze the agent specification to predict security vulnerabilities, performance bottlenecks, compliance issues, and/or the like, before registration of the agent specification. In an alternative embodiment, validation engine 370 may be omitted.

When validation engine 370 is unable to automatically validate the agent specification—for example, because the agent specification is missing one or more fields, is logically inconsistent, or is missing an interdependent component—validation engine 370 may flag the agent specification for human review. In this case, the agent specification may be blocked from registration until a human has reviewed and validated the agent specification. Validation engine 370 may return a notification to end client 310 which notifies end client 310 of the issue(s) preventing validation of the agent specification. In the event that end client 310 is a user (e.g., in an embodiment in which registration service 116 is a conversational AI agent 160), this notification may be in the form of a natural-language expression (e.g., generated by a generative language model, such as a large language model), and the user may respond with any information required to complete validation of the agent specification and/or manually correct the agent specification.

In an embodiment, validation engine 370 may identify missing components within the agent specification and highlight these missing components to end client 310. For instance, if the agent definition, as represented in input file 320, is missing guardrails, validation engine 370 may prompt end client 310 with a suggestion to add guardrails to the agent specification. As another example, if the agent definition, as represented in input file 320, is missing a component on which an existing component depends (e.g., as determined by cross-referencing validation), validation engine 370 may prompt end client 310 with a suggestion to add the missing component. Thus, end clients 310 may be informed of any gaps in their agent specifications. In other words, validation engine 370 may identify gaps in agent specifications, suggest missing fields to be completed, missing components to be added, and/or the like, based on what is historically provided for similar AI agents 160.

Registration module 380, which may be implemented within registration service 116, may add the agent specification, generated by standardization engine 360 and potentially validated by validation engine 370, to registry 118 of AI agents 160. Registry 118 may be accessible via an application programming interface 119. Registration module 380 may be configured to authenticate with registry 118 and insert the new agent specification into registry 118 (e.g., using one or more authorized controls), via application programming interface 119. In particular, registration module 380 may perform a remote procedure call to an endpoint within application programming interface 119 of registry 118, using the agent specification as an input, to add the agent specification to registry 118.

Application programming interface 119 may comprise one or more security features. The security feature(s) may comprise validation and sanitization of agent specifications, being added to registry 118, to prevent injection attacks, rate limiting to prevent abuse of the automated registration capabilities, audit logging of all registration activities for compliance, and/or the like.

Application programming interface 119 may maintain version numbers for each agent specification for each AI agent 160 in registry 118, as the agent specification evolves over time. Version numbers may be updated by application programming interface 119 according to a semantic versioning schema. The semantic versioning schema may utilize a major version number and one or more minor version numbers, with updates to different version numbers representing different types of changes or impacts. Application programming interface 119 may automatically update these version numbers, as changes to an agent specification are made via application programming interface 119. Application programming interface 119 may also support differential updates that consist of only the changes between two versions of an agent specification, rather than the entire new version of the agent specification, along with impact analysis reporting. Registry 118 may store every version of an agent specification, such that historical versions of the agent specification may be retrieved for the purposes of compliance, auditing, rollback, and the like.

Application programming interface 119 may also have branch and merge capabilities, which enable collaborative development. For example, application programming interface 119 may comprise one or more operations for creating a branch version of an existing agent specification and/or for merging two versions of an agent specification.

Application programming interface 119 may implement an impact assessment engine that evaluates the potential effects of modifications to an agent specification of an AI agent 160 on workflows and systems that utilize the AI agent 160. For example, application programming interface 119 may comprise one or more operations for obtaining the potential effects of one or more modifications to an agent specification stored within registry 118.

Application programming interface 119 may implement or support a visualization of a dependency graph. The dependency graph may map relationships between an AI agent 160 and connected systems (e.g., models 162, tools 164, etc.). For example, application programming interface 119 may comprise one or more operations that returns a representation of the dependency graph for an AI agent 160, which can then be converted into a visual representation.

Application programming interface 119 may implement version compatibility scoring to identify potential integration issues when an agent specification is modified. For example, application programming interface 119 may comprise one or more operations that return a version compatibility score. The version compatibility score may represent a compatibility between two versions of an agent specification, which may correspond, for instance, to how significant the subsequent version deviates from the prior version.

Application programming interface 119 may implement one or more rollback mechanisms with automated state preservation for reverting problematic updates. For example, application programming interface 119 may comprise one or more operations that revert an agent specification to a prior version of the agent specification. These operation(s) may be used when an update to an agent specification results in issues that are determined to require a roll back from the current version of the agent specification to a prior version of the agent specification.

Application programming interface 119 may implement a policy engine with governance rules. For example, application programming interface 119 may implement comprehensive role-based access control (RBAC) for granular permission management across registry 118. Application programming interface 119 may also support configurable approval workflows for an agent specification based on the sensitivity of the corresponding AI agent 160 being approved, data access requirements, the organizational hierarchy applicable to the approval workflow, and/or the like. In addition, application programming interface 119 may enforce compliance rules for industry-specific regulations, such as General Data Protection Regulation (GDPR), Health Insurance Portability and Accountability Act (HIPAA), and/or the like, with automated validation of agent specifications against policy requirements. Application programming interface 119 may also provide audit and monitoring capabilities that track the usage of registry 118, modifications to agent specifications in registry 118, and access patterns for registry 118, for compliance reporting.

Application programming interface 119 may implement one or more quality assurance mechanisms. For example, each agent specification may be stored in association with its confidence score. In addition, application programming interface 119 may generate one or more completeness metrics for each agent specification, representing whether or not the agent specification is missing information and/or how much information is missing from the agent specification. Application programming interface 119 could also implement a recommendation engine that generates suggestions for improving an agent specification, and/or a notification system for alerting end client 310 of potential issues with an agent specification.

Data flow 300 may be incorporated into any of various registration workflows. In an embodiment, the registration workflow may branch based on the confidence score for the automatically generated agent specification for an AI agent 160 to be registered. For example, as discussed above, a confidence score may be generated for each agent specification that is output by standardization engine 360. When the confidence score satisfies (e.g., is greater than or equal to) a threshold, representing high confidence, the agent specification may be added to registry 118 automatically without any user intervention required. When the confidence score does not satisfy (e.g., is less than) the threshold, representing low confidence, the workflow may require a human in the loop to review and confirm the agent specification before addition to registry 118. In other words, the addition of the new agent specification to registry 118 is blocked until a user approval is received. Similarly, when an AI agent 160 is highly sensitive or will have a high impact (e.g., utilizes sensitive data or performs a critical task), the workflow may require a human in the loop to review and confirm the agent specification before addition to registry 118. Data flow 300 may also be used in bulk registrations to migrate one or more existing registries of AI agents 160 into unified registry 118.

### 4. Process

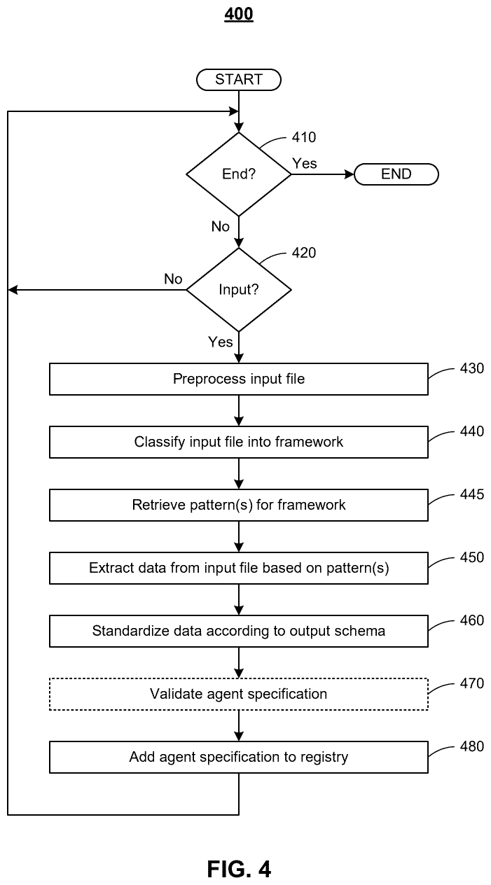

FIG. 4 illustrates an example process 400 for automated multi-modal registration of artificial intelligence (AI) agents, according to an embodiment. Process 400 may be implemented by registration service 116, which may be a software module of server application 112 or a separate software entity, including potentially, an AI agent 160 that utilizes one or more models 162 and one or more tools 164. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Process 400 may continue for as long as registration service 116 is operational, and end when the operation of registration service 116 is terminated. When determining to end process 400 (i.e., “Yes” in subprocess 410), process 400 may end. Otherwise, when not determining to end process 400 (i.e., “No”in subprocess 410), process 400 may proceed to subprocess 420.

Subprocess 420, which may be implemented by ingestion engine 330, may determine whether or not a new input file 320 has been received. An input file 320 represents at least a portion of the definition of an AI agent 160. While the singular form is used for the term “input file,” it should be understood that input file 320 could comprise one or a plurality of computer files. Input file 320 may include, without limitation, a resource (e.g., identified by a URL) of a code repository, a code file (e.g., comprising the source code for AI agent 160), one or more image files (e.g., representing screenshots of a configuration interface for AI agent 160), a PDF file, a configuration file (e.g., XML file), a plain text file, and/or the like. In the event that input file 320 is indicated as a URL of a code repository, subprocess 420 may retrieve the resource at the URL to be included in input file 320.

Subprocess 430, which may be implemented by ingestion engine 330, may preprocess input file 320 that was received in subprocess 420. For example, if input file 320 is a container (e.g., archive file) comprising a plurality of computer files, subprocess 430 may extract the plurality of computer files. Subprocess 430 may also automatically detect the format of input file 320, extract characteristic data from input file 320 based on the detected format, normalize the characteristic data, and/or the like. In an alternative embodiment, subprocess 430 may be omitted.

Subprocess 440, which may be implemented by classifier 340, may classify the input file, received in subprocess 420 and potentially preprocessed in subprocess 430, into one of a plurality of frameworks. The plurality of frameworks may comprise any framework that is used to define AI agents 160, including, for example, CrewAI, LangChain, LlamaIndex, Salesforce Einstein, Workday Adaptive Planning, Microsoft AutoGen, Auto-GPT, MetaGPT, ServiceNow AI Agents, Adobe Experience Platform Agent Orchestrator, and/or the like. The plurality of frameworks may comprise two or more versions of the same framework (e.g., all supported versions of all of the supported frameworks), to support version detection.

In an embodiment, subprocess 440 derives one or more, and generally a plurality of, features from the structured data, output by subprocess 430, and applies a classification model to the plurality of features to classify input file 320 into one of the plurality of frameworks. The classification model may comprise a rule-based model and/or a machine-learning model. In a preferred embodiment, the classification model is an ensemble model that comprises at least one rule-based algorithm and at least one machine-learning algorithm, and determines a final classification based on an aggregation of the outputs of the rule-based model(s) and the machine-learning model(s).

In an embodiment, the machine-learning model(s) utilizes a vector database, stored within knowledge base 345. In this case, classifying input file 320 into one of the plurality of frameworks may comprise extracting one or more input schema patterns from input file 320, as the features. For each of the input schema pattern(s), the input schema pattern may be converted into an input embedding vector, and the vector database may be searched for any reference embedding vectors that are similar to the input embedding vector according to a similarity metric. Each of the reference embedding vectors is associated (e.g., tagged) with one of the plurality of frameworks. Subprocess 440 may determine the final classification of the framework, at least in part, based on the frameworks that are associated with the reference embedding vectors that are found in the search. For example, if more than one framework is returned, the final classification may be the framework that is associated with the reference embedding vectors having the highest overall similarity, according to the similarity metric, to the input embedding vector(s). Alternatively, the final classification may be determined in any other suitable manner from the subset of frameworks associated with the matching reference embedding vectors. The output of subprocess 440 may be a framework identifier of the determined framework, potentially with a confidence score for the determination. The confidence score may be based on the similarity metric(s) for the matching reference embedding vector(s) associated with the determined framework.

Subprocess 445, which may be implemented by classifier 340 or extraction handler(s) 350, may retrieve one or more patterns for the framework, into which the input file was classified in subprocess 440. For example, patterns for each of the plurality of frameworks may be stored in knowledge base 345. Subprocess 445 may retrieve all pattern(s) associated with the determined framework, using the framework identifier output by subprocess 440.

Subprocess 450, which may be implemented by extraction handler(s) 350, may extract data from input file 320, received in subprocess 420 and potentially preprocessed in subprocess 430, based on the pattern(s) that were retrieved in subprocess 445. In particular, a specialized extraction handler 350 may be instantiated for the framework, determined in subprocess 440, and/or for each pattern retrieved in subprocess 445. In the event that a plurality of specialized extraction handlers 350 are instantiated, the plurality of specialized extraction handlers 350 may be executed in parallel. Each extraction handler 350 may extract data from input file 320 based on the respective pattern(s). For instance, for each portion of input file 320 that matches a pattern, extraction handler 350 may extract data from that portion of input file 320 based on the pattern (e.g., template). In other words, data may be extracted from each portion of input file 320 that matches one of the pattern(s) used by extraction handler 350.

Subprocess 460, which may be implemented by standardization engine 360, may standardize the data, extracted in subprocess 450, according to a standard agent schema. In particular, subprocess 460 may apply an AI model (e.g., an AI model 162 in an embodiment in which registration service 116 or standardization engine 360 is an AI agent 160) to the extracted data to generate an agent specification for the AI agent, represented by input file 320 that was received in subprocess 420, according to a standard agent schema that is used for all agent specifications in registry 118.

The AI model may be a generative language model, such as a large language model (e.g., Claude Sonnet). In this case, subprocess 460 may incorporate the data, extracted in subprocess 450, into a prompt that is input to the generative language model. For example, subprocess 460 may generate a prompt (e.g., using a template) that comprises at least a portion of the extracted data, the standard agent schema, and/or an instruction to generate an agent specification in the standard agent schema using the extracted data. Subprocess 460 may then input this prompt to the generative language model to produce the agent specification, according to the standard agent schema. The generative language model may be fine-tuned to generate agent specifications according to the standard agent schema.

In an embodiment, the AI model generates both the agent specification and a at least one confidence score for the agent specification. The confidence score(s) may comprise a confidence score for the entire agent specification and/or a confidence score for each field in the agent specification or a subset of fields in the agent specification. Each confidence score may represent how confident the AI model is about the correctness, including completeness, of the agent specification or respective field. The confidence score may be a numerical value within a range of zero to one or zero to one hundred, with zero representing no confidence and one or one hundred representing perfect confidence. The confidence score for the entire agent specification may be a composite confidence score that is generated as an aggregation (e.g., average, weighted average, ratio of completed fields to total fields, etc.) of the confidence scores for the fields in the agent specification.

Subprocess 470, which may be implemented by validation engine 370, may validate the agent specification that was output by subprocess 460. Subprocess 470 may ensure that the agent specification contains values for all required fields, that the agent specification is internally consistent, contains all components from which other components depend, and/or the like. In addition, subprocess 470 may identify any missing field values and/or components in the agent specification, and prompt the end client 310 (e.g., a user or software entity) that submitted input file 320 to address the missing field values and/or components.

In an embodiment, validation may be based on the confidence score(s), output by subprocess 460. For example, when the confidence score for the entire agent specification satisfies (e.g., is greater than or equal to) a threshold, representing high confidence, validation engine 370 may determine to automatically validate the agent specification. Otherwise, when the confidence score does not satisfy (e.g., is less than) a threshold (e.g., the same threshold), representing low confidence, validation engine 370 may determine not to automatically validate the agent specification, and instead, execute a fallback process. The fallback process may notify end client 310 and/or prompt end client 310 for feedback. In the event that end client 310 is a user, the notification may indicate that the agent specification could not be automatically validated and the reason(s) that the agent specification could not be automatically validated, and/or one or more inputs for approving the agent specification despite any issues preventing automatic validation, modifying the agent specification to correct any issues preventing automatic validation, and/or disapproving of the agent specification. In general, when determining not to automatically validate the agent specification, the addition of the agent specification to registry 118 may be blocked until an approval of the agent specification (e.g., with or without modification) is received. In an alternative embodiment, subprocess 470 may be omitted.

Subprocess 480, which may be implemented by registration module 380, may add the agent specification, output by subprocess 460 and potentially validated in subprocess 470, to registry 118 of AI agents 160. In particular, subprocess 480 may perform a remote procedure call to an endpoint within application programming interface 119 of registry 118, using the agent specification as an input. After the agent specification has been added to registry 118, process 400 may return to subprocess 410.

As discussed elsewhere herein, application programming interface 119 may comprise security feature(s) to prevent injection attacks, denial of service (DoS) attacks, and/or the like. In addition, application programming interface 119 may maintain version numbers for each added agent specification, according to a semantic versioning schema. Application programming interface 119 may also provide other tools, including branch and merge capabilities, an impact assessment engine, dependency graphing, compatibility scoring, rollback mechanisms, a policy engine with governance rules, quality assurance mechanisms, and/or the like.

As soon as an agent specification has been added to registry 118, it may become immediately available to other entities (e.g., users or software entities) in real time. For example, users may be able to search registry 118 for AI agents 160 that can be used for desired tasks. As another example, an AI agent 160 or other software entity may search registry 118 for another AI agent 160 that it can utilize as a tool 164. Thus, registration of an agent specification for an AI agent 160 immediately effectuates the deployment of that AI agent 160, for example, to computing environment 150.

### 5. Example Embodiment

Disclosed embodiments provide an automated solution for generating agent specifications for AI agents 160 from diverse input formats, and registering the generated agent specifications in a standardized manner within a registry 118 of AI agents 160. Embodiments employ multi-modal processing of input files 320 to analyze, classify, and extract structured data about AI agents 160, regardless of the specific input formats and regardless of the original frameworks in which the AI agents 160 were defined. Using specialized extraction handlers 350 and a robust knowledge base 345, embodiments can dramatically reduce friction in the registration of AI agents 160, while maintaining standardized agent specifications across different AI frameworks and platforms.

Embodiments eliminate manual installation requirements, using automated multi-modal registration. Previously, a human would have to manually extract data, generate the agent specification, and register the agent specification. This would typically take hours, whereas disclosed embodiments can perform the entire registration process in seconds or minutes, and without the need for human involvement. In addition, embodiments can perform this registration process directly from static artifacts, which eliminates operational overhead and security concerns.

Embodiments provide multi-modal input support. In particular, as discussed elsewhere herein, both visual and document-based agent definitions can be ingested via multi-modal processing. This dramatically expands the sources of agent definitions that can be ingested, beyond code-based definitions. Disclosed embodiments provide consistent classification, data extraction, specification generation, and agent registration, regardless of the input format and framework, thereby improving the searchability and discoverability of relevant AI agents 160.

Embodiments produce a unified registry 118 of AI agents 160, regardless of the source of agent definitions and regardless of the framework used to define AI agents 160. As a result, agent specifications are standardized across heterogenous frameworks (e.g., CrewAI, LangChain, LlamaIndex, etc.), ensuring a consistent representation of agentic capabilities, requirements, and limitations. This enables cross-platform discovery and management of AI agents 160, and provides centralized governance and visibility of AI agents 160 across an organization, which supports compliance and security requirements.

Embodiments provide an automated connection configuration. In particular, instead of requiring a connector configuration for AI agents 160 to be manually specified, the connector configuration may be automatically detected using intelligent detection of the input format and automated processing pipelines for the different input formats. This reduces setup time from days to seconds or minutes, and eliminates the need for a user to have specialized connector knowledge.

Embodiments provide an AI-enhanced translation layer. In particular, the AI-powered classifier 340 and/or standardization engine 360, with knowledge-based schema mapping capabilities, are able to adapt to new frameworks without manual updates or configuration changes. Thus, registration service 116 is able to evolve as frameworks evolve and automatically adapt to the emergence of new capabilities in the market of AI agents 160.

Embodiments provide comprehensive specification extraction. In particular, extraction handlers 350 operate beyond basic metadata collection, to extract capabilities, limitations, model requirements, interaction patterns, and/or the like, of the defined AI agent 160. This provides substantial value for governance and discovery.

Embodiments do not require any modifications to an existing registry 118. In particular, registration service 116 maintains full compatibility with any existing registry 118, using application programming interface 119. Thus, registration service 116 can be easily integrated with an existing registry 118. This ensures that existing investments in registry 118 and workflows that utilize registry 118 continue to function as normal, while adding new capabilities.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a registration service:
receive an input file defining an artificial intelligence (AI) agent;
classify the input file into one of a plurality of frameworks, wherein each of the plurality of frameworks is a framework by which the AI agent may be defined;
retrieve one or more patterns for the one framework;
extract data from the input file based on the one or more patterns;
apply an AI model to the extracted data to generate an agent specification for the AI agent according to a standard agent schema; and
add the agent specification to a registry of AI agents.

2. The method of claim 1, further comprising using the at least one hardware processor to, by the registration service, before adding the agent specification to the registry of AI agents, validate the agent specification.

3. The method of claim 1, further comprising using the at least one hardware processor to, before classifying the input file:
detect a format of the input file; and
extract characteristic data from the input file, based on the detected format.

4. The method of claim 3, wherein classifying the input file into the one framework comprises:
deriving a plurality of features from the characteristic data; and
applying a classification model to the plurality of features to classify the input file into the one framework.

5. The method of claim 4, wherein the plurality of frameworks comprises two or more versions of a same framework.

6. The method of claim 4, wherein the classification model is an ensemble model that comprises at least one rule-based model and at least one machine-learning model.

7. The method of claim 1, wherein classifying the input file into one of the plurality of frameworks comprises:
extracting one or more input schema patterns from the input file;
for each of the one or more input schema patterns,
converting the input schema pattern into an input embedding vector,
searching a vector database for any reference embedding vectors that are similar to the input embedding vector according to a similarity metric, wherein each of the reference embedding vectors is associated with one of the plurality of frameworks; and
determining the one framework based on the frameworks that are associated with the reference embedding vectors that are found in the search.

8. The method of claim 1, wherein extracting data from the input file based on the one or more patterns comprises extracting data from each portion of the input file that matches one of the one or more patterns.

9. The method of claim 1, wherein the AI model is a generative language model, and wherein applying the AI model to the extracted data comprises:
generating a prompt that comprises at least a portion of the extracted data; and
inputting the prompt to the generative language model to produce the agent specification.

10. The method of claim 9, wherein the prompt further comprises the standard agent schema.

11. The method of claim 1, wherein the AI model generates both the agent specification and a confidence score for the agent specification, wherein the confidence score represents how confident the AI model is about the correctness of the agent specification.

12. The method of claim 11, further comprising using the at least one hardware processor to, by the registration service, determine whether or not to automatically validate the agent specification based on the confidence score.

13. The method of claim 12, wherein determining whether or not to automatically validate the agent specification comprises:
determining to automatically validate the agent specification when the confidence score satisfies a threshold; and
determining not to automatically validate the agent specification when the confidence score does not satisfy the threshold.

14. The method of claim 13, further comprising using the at least one hardware processor to, by the registration service, when determining to automatically validate the agent specification, automatically add the agent specification to the registry without user involvement.

15. The method of claim 13, further comprising using the at least one hardware processor to, by the registration service, when determining not to automatically validate the agent specification, block the addition of the agent specification to the registry until an approval of the agent specification is received.

16. The method of claim 1, wherein adding the agent specification to the registry comprises performing a remote procedure call to an endpoint within an application programming interface of the registry.

17. The method of claim 1, wherein the registration service is hosted on an integration platform as a service (iPaaS) platform.

18. The method of claim 1, wherein the plurality of frameworks comprises two or more different frameworks and two or more versions of a same framework.

19. A system comprising:
at least one hardware processor; and
software that is configured to, when executed by the at least one hardware processor, perform the method of claim 1.

20. A non-transitory computer-readable medium having instructions stored therein, wherein the instructions, when executed by a processor, cause the processor to perform the method of claim 1.
